(19) United States
(12) Patent Application Publication
(10) Pub. No.: US 2019/0313334 A1
(43) Pub. Date: Oct. 10, 2019

(54) ROVING COLLECTOR

(71) Applicant: Dharma Platform, Inc., Washington, DC (US)

(72) Inventors: Stefan Anastas Nagey, Washington, DC (US); Jesse Erin Berns, Washington, DC (US); Michael Roytman, Washington, DC (US)

(21) Appl. No.: 16/385,453

(22) Filed: Apr. 16, 2019

Related U.S. Application Data
(63) Continuation of application No. 15/809,320, filed on Nov. 10, 2017, now abandoned.
(60) Provisional application No. 62/565,928, filed on Sep. 29, 2017.

(51) Int. Cl. H04W 52/02; G01D 11/24; G01D 5/00; H04L 29/08; H04W 4/70; G01D 9/02; G01D 21/00; G01D 9/00

(52) U.S. Cl. CPC H04W 52/0225; G01D 11/245; G01D 5/00; H04L 67/12; H04W 12/06; G01D 9/02; G01D 21/00; G01D 9/005; H04W 4/70

(57) ABSTRACT

Presented here are system and methods for collecting information from devices, such as sensors, that are not necessarily connected to the Internet. Multiple sensors are distributed in a geographic area. The sensors power up every 10 minutes to gather data about the environment and then power down to save battery. A collecting device, i.e., a device attached to a moving object, traverses the geographic area containing the sensors, and continuously sends wake-up signals into the environment. When a sensor is within 20 feet of the collecting device, and receives the wake-up signal, the sensor uploads the gathered data to the collecting device. Subsequently, when the collecting device establishes an Internet connection, the collecting device uploads the gathered data to a central database.

### CROSS-REFERENCE TO RELATED APPLICATIONS

This application is a continuation of U.S. patent application Ser. No. 15/809,320, filed Nov. 10, 2017, which claims priority to the U.S. Provisional Patent Application Ser. No. 62/565,928 filed Sep. 29, 2017, which applications are incorporated herein by this reference in their entirety.

### TECHNICAL FIELD

The present application is related to data collection, and more specifically to methods and systems that collect data from distributed sensors.

### BACKGROUND

Many simple and complex devices can be connected to the Internet, such as supercomputers, personal computers, tablets, mobile phones, thermostats, sensors, etc. The Internet connection is crucial because it allows remote communication with and remote control of the Internet connected devices. For example, we can turn on the thermostat in our houses while driving back home from work. However, if the Internet connection fails, or the device is not connected to the Internet, the remote communication and control cease to work.

### SUMMARY

Presented here are system and methods for collecting information from devices, such as sensors, that are not necessarily connected to the Internet. In one embodiment, multiple sensors are distributed in a geographic area such as a city. The sensors are cheap and may not have the capability to connect to the Internet. The sensors can power up every 10 minutes to gather data about the environment, such as the ambient temperature, and then power down to save energy. The sensors can collect a maximum of 50 data points, at which point, the sensors delete the data in memory, and start recording measurements again.

A collecting device, i.e., a device attached to a moving object such as a bus, traverses the geographic area containing the sensors, and continuously sends out wake-up signals into the environment. When a sensor is within, for example, 10 m of the collecting device, and receives the wake-up signal, the sensor uploads the gathered data to the collecting device. Subsequently, when the collecting device establishes an Internet connection, the collecting device uploads the gathered data to a central database. As a result, the sensor consumes little energy, and can operate with a small battery, because the sensor spends most of the time power down, and only uses energy to record a measurement, and to upload the data to the collecting device.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows a system including multiple sensors distributed over various locations, and a collecting device.

FIG. 2 shows the communication system between the collecting device and the sensors.

FIG. 3 shows a path collecting device can take to gather the sensor data.

FIG. 4 shows a dual-mode device.

FIG. 5 is a flowchart of a method to collect data over a geographic area using inexpensive sensors.

FIG. 6 shows a collecting device.

FIG. 7 is a flowchart of a method to collect data from various dual-mode devices dispersed over a geographic area using a roving collecting device.

FIG. 8 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### System Overview

Presented here are system and methods for collecting information from devices, such as sensors, that are not necessarily connected to the Internet. In one embodiment, multiple sensors are distributed in a geographic area such as a city. The sensors are cheap and may not have the capability to connect to the Internet. The sensors power up every 10 minutes to gather data about the environment, such as the ambient temperature, and then power down to save energy. The sensors can collect a maximum of 50 data points, at which point, the sensors delete the data in memory, and start recording measurements again.

A collecting device, i.e., a device attached to a moving object such as a bus, traverses the geographic area containing the sensors, and continuously sends out wake-up signals into the environment. When a sensor is within 20 feet of the collecting device, and receives the wake-up signal, the sensor uploads the gathered data to the collecting device. Subsequently, when the collecting device establishes an Internet connection, the collecting device uploads the gathered data to a central database. As a result, the sensor consumes little energy, and can operate with a small battery, because the sensor spends most of the time power down, and only uses energy to record a measurement, and to upload the data to the collecting device.

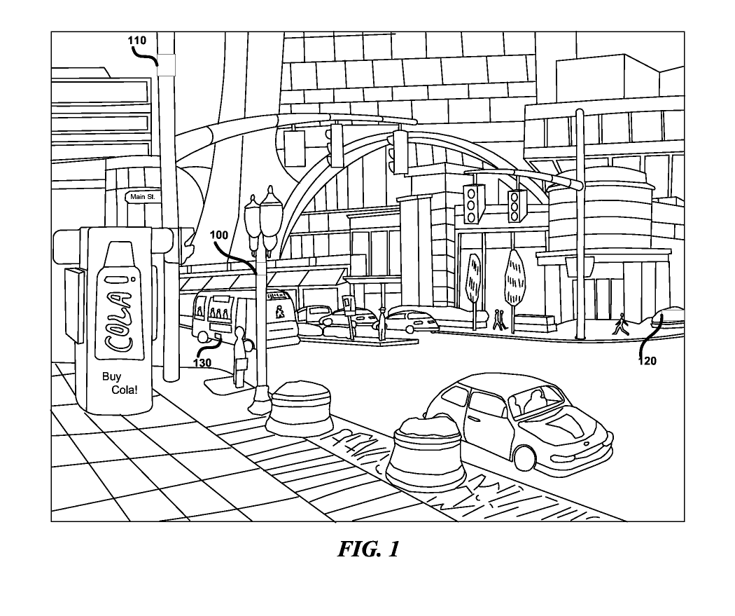

FIG. 1 shows a system including multiple sensors 100, 110, 120 distributed over various locations, and a collecting device 130. Multiple sensors 100, 110, 120 can be distributed at different geographic locations, such as within a city as shown in FIG. 1, within a county, a state, country, etc. To preserve energy the sensors 100, 110, 120 can operate in at least two modes, a low-energy mode, and a high-energy mode. When operating in the high-energy mode, the sensors 100, 110, 120 can collect information such as ambient temperature, ambient light, ambient humidity, ambient noise, radio signals, etc. The sensors 100, 110, 120 can be stationary. Upon completing the measurement, the sensors 100, 110, 120 transition to the low-energy mode where they utilize a low amount of energy. The sensors 100, 110, 120 sensors are asleep most of the time, until a time arrives to make a measurement, such as every 10 minutes, and/or until a time arrives to transmit the data to the collecting device 130 i.e., the roving collector. In other examples, the sensors 100, 110, 120 can wake every 5 seconds, every day, or wake at a user-specified frequency.

The collecting device 130 is a device that can move across different geographic locations. The collecting device 130 can be attached to a pedestrian, a vehicle such as a bus, a car, a self-driving car, a drone, a bike, etc. The collecting device 130 utilizes more energy than the sensors 100, 110, 120 because the collecting device 130 is powered up most of the time. The collecting device 130 can be a software application running on a mobile device. As the collecting device 130 traverses a geographic area, the collecting device wakes up sensors 100, 110, 120 that it encounters and downloads the data from the sensors 100, 110, 120. For example, the collecting device 130 continuously sends out a wake-up signal that has a range of approximately 20 feet. If the sensor 100, 110, 120 is within 20 feet of the collecting device, the sensor 100, 110, 120 wakes upon receiving the wake-up signal, and sends the data collected to the collecting device 130. The maximum communication distance between the sensor and the collecting device can vary, and can be a short distance, for example a range similar to the Bluetooth protocol's 10 m, or can extend up to 100 m.

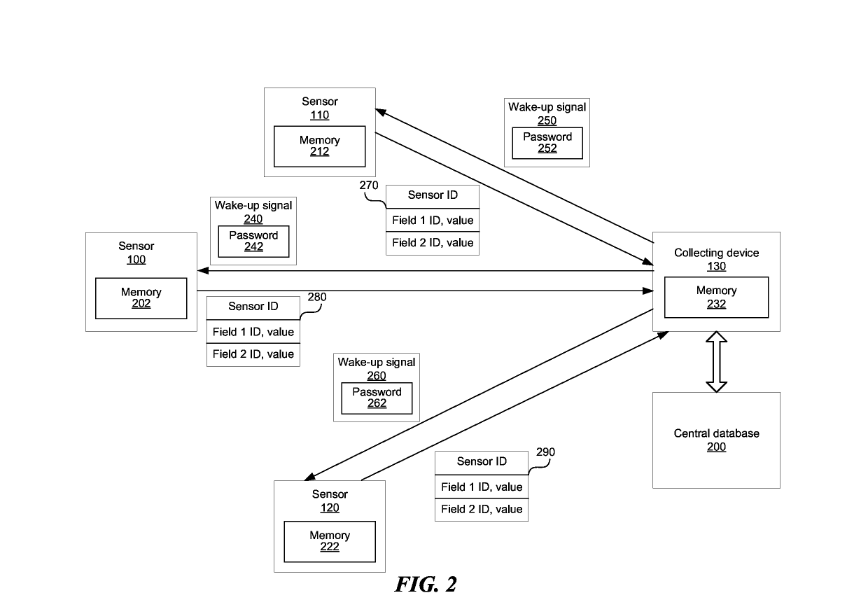

FIG. 2 shows the communication system between the collecting device and the sensors. The sensors 100, 110, 120 can store the collected information into memory 202, 212, 222 in a data structure such as a queue or a stack. The sensors 100, 110, 120 are cheap, under $10, and preferably up to $3, and have a limited amount of memory. Once the memory 202, 212, 222 has been filled to the capacity, the sensor can delete all the data in memory 202, 212, 222 and start recording anew, or can start by rewriting existing data in memory 202, 212, 222. In some embodiments, the sensors 100, 110, 120 communicate among each other.

For example, the sensors 100, 110, 120 can power up every 10 minutes, record a measurement, such as a strength of a radio signal, strength of Wi-Fi connections, etc. and can store up to a predetermined number of measurements, such as 50 measurements. If the collecting device 130 establishes contact with the sensor 100, 110, 120 every 500 minutes, the collecting device 130 receives all of the data and can store the data in memory 232. However, if the collecting device 130 does not reach the sensor within 500 minutes, the sensor 100, 110, 120 can delete all of the data contained on the sensor, or overwrite old data.

The collecting device 130 can wake up the sensors 100, 110, 120 by continually emitting a wake-up signal 240, 250, 260 using near field communication, such as Bluetooth. Alternatively, or in addition, the collecting device 130 can emit the wake-up signal 240, 250, 260 when the collecting device detects the presence of a network such as Wi-Fi, cellular network, mesh network, local area network, metropolitan area network, etc.

To avoid waking up sensors that are part of a different network, or waking up sensors that do not need to be woken up, the wake-up signal 240, 250, 260 sent to the sensors 100, 110, 120 can contain a password 242, 252, 262 shared between the collecting device 130 and the sensor 100, 110, 120, respectively. The passwords 242, 252, 262 can be the same, can all be different, or some can be the same and some can be different. If the sensor 100, 110, 120 recognizes the received password, the sensor 100, 110, 120 sends the data 270, 280, 290 to the collecting device 130. The password can be constructed to guard against replay attacks, etc. Upon receiving the data 270, 280, 290, the collecting device 130 stores the data in memory 232, and in addition records the time and position when the data was received.

The data 270, 280, 290 sent to the collecting device can contain an identification (ID) of the sensor 100, 110, 120, ID for data field number 1, the value for data field number 1, ID for data field number 2, value for data field number 2, etc. The sensor ID can be pre-programmed and unique to the device. The sensor ID can be a media access control (MAC) address, an International Mobile Equipment Identity (IMEI) number, and/or a randomly generated globally unique ID recorded into an EPROM, etc.

Once the collecting device 130 receives the data 270, 280, 290, the collecting device can integrate the data into a database by mapping the sensor ID, and data field ID into a project in the database. The mapping can be done by retrieving a table which associates the sensor ID with a database project, and the data field ID to a response in the database project. Alternatively, the collecting device can transmit the data to a central database 200, which then can map the sensor ID and the data field ID into the project and a response in the central database 200.

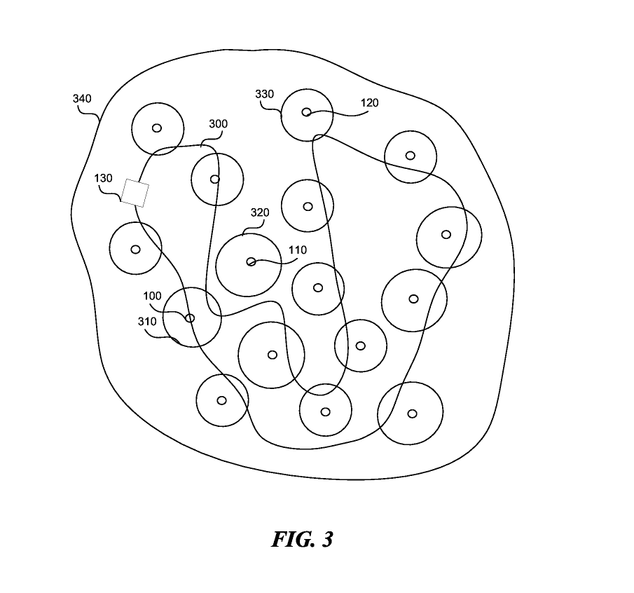

FIG. 3 shows a path collecting device can take to gather the sensor data. Perimeter 340 limits the region within which the sensors are placed. The collecting device 130 can follow the path 300 through the sensors 100, 110, 120 (only three labeled for brevity). The region 310, 320, 330 (only three labeled for brevity) shows a distance within which the collecting device 130 needs to approach the sensor 100, 110, 120 to be able to collect sensor data. The distance can usually be about 20 feet. The collecting device 130 can take on various paths, such as visit each of the sensors 100, 110, 120 once such as sensor 120, visit at least one sensor at least twice such as sensor 100, skip visiting the sensor altogether such as sensor 110, etc.

### Dual-Mode Devices

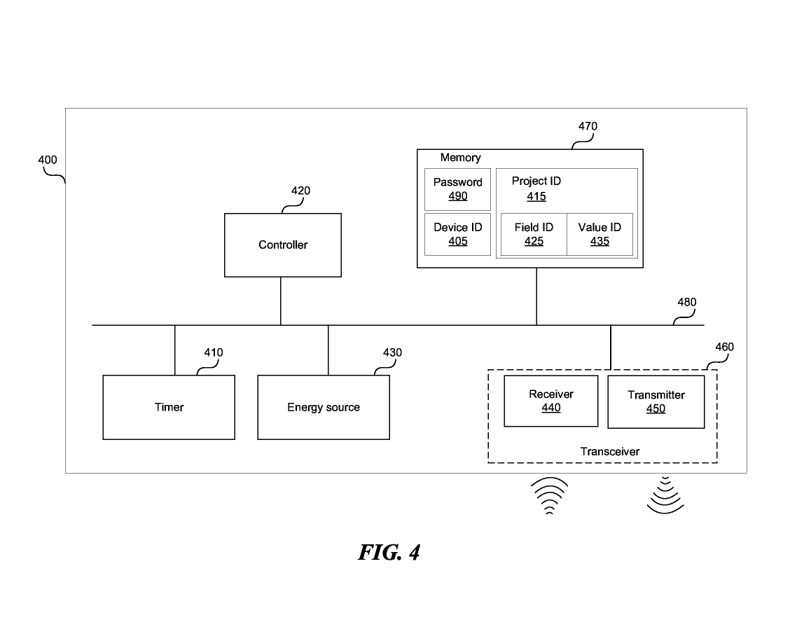

FIG. 4 shows a dual-mode device. The dual-mode device 400 can be one of multiple dual-mode devices geographically distributed and without an Internet connection as shown in FIG. 1. The dual-mode device 400 can be a sensor to measure one or more environment properties such as temperature, light, noise, humidity, wind, air quality, available wireless networks, cell phone reception, etc. The dual-mode device can include a timer 410, one or more controllers 420, an energy source 430, a receiver 440, a transmitter 450, an optional transceiver 460, and a memory 470, all communicating with each other via a bus 480. The controller 420 can be a microcontroller, and/or a processor associated with the device 400.

A first mode of the dual-mode device 400 includes a high-energy mode to record and transmit data, and a second mode of the dual-mode device includes a low-energy mode to determine whether to transition to the first mode. The dual-mode device 400 spends most of the time in the low-energy mode to minimize energy consumption. The dual-mode device 400 can transition from the low-energy mode to the high-energy mode in at least two ways. For example, the dual-mode device 400 can be woken up by a collecting device 130 in FIGS. 1-2, or the dual-mode device 400 can be woken up after a predetermined passage of time, as described in this application. The dual-mode device 400 transitions from the high-energy mode to the low-energy mode upon completing a task associated with the high-energy mode.

The energy source 430 can provide energy to the dual-mode device 400. The energy source 430 can include a battery providing electrical current to the dual-mode device 400, a solar cell, and/or a converter to convert energy from the environment into energy consumed by the dual-mode device 400. The solar cell can be flexible and detachable, and can be moved between various dual-mode devices 400. The converter can also be detachable, and can, for example, convert vibrations from the environment, such as wind and/or surface vibrations, into electrical energy used by the dual-mode device 400.

The energy consumption is higher in the high-energy mode than in the low-energy mode. When depleted, the energy source 430 can be recharged, replaced, or the whole dual-mode device 400 can be discarded due to a low cost of the dual-mode device 400. The dual-mode device 400 can be made out of biodegradable conductive materials such as polypyrrole (PPy) nanoparticles and poly(d,l-lactide) (PDLLA), or PPy-coated polyester fabric. The content of PPy in the biodegradable conductive material can vary between 1-20%. The dual-mode device 400 can disintegrate into the environment once the energy source 430 is drained.

The timer 410 can measure the passage of time when the dual-mode device 400 is operating in the low-energy mode. When a predetermined amount of time has passed since the last measurement, such as 15 minutes, the timer 410 can send a message to the controller 420, via the bus 480, to transition the device 400 into the high-energy mode.

The receiver 440 can receive a message sent out by the collecting device 130 when the dual-mode device 400 is operating in the low-energy mode. The message sent out by the collecting device 130 can contain a wake-up signal 240, 250, 260 in FIG. 2 indicating to the dual-mode device 400 to transition to the high-energy mode. The message can also contain a new password associated with the dual-mode device 400, a new ID for the dual-mode device 400, a new ID for a project associated with a dual-mode device 400, or a new ID for one or more of the values collected by the dual-mode device 400. Once the receiver 440 receives the message, the receiver 440 can transition the dual-mode device 400 to the high-energy mode.

The controller 420 can also transition the dual-mode device 400 into the high-energy mode once the message is received, or the controller 420 can authenticate the received message before transitioning the dual-mode device 400 into the high-energy mode. To authenticate the received message, the controller 420 can compare the received message to a password 490 stored in the memory 470 of the dual-mode device 400. The controller 420 can authenticate the received message when the password 490 and the received message are the same.

The transmitter 450 can transmit messages wirelessly over short distances equal to or less than 100 m. Communication over short distances minimizes energy usage. As a result the lifetime of the energy source 430 can be extended. The transmitter 450 and the receiver 440 can be combined into a single transceiver 460 performing the functions of both the transmitter 450 and the receiver 440.

The dual-mode device 400 can guard against various security attacks. For example, the controller can guard against a replay attack. A replay attack is a form of network attack in which a valid data transmission is maliciously or fraudulently repeated or delayed. To guard against the replay attack, the dual-mode device 400 receives a message containing a password encoded with a time at which the password was sent to the dual-mode device 400. The controller 420 obtains a receiving time when the message was received, and constructs a time window surrounding the receiving time. For example, the time window can be two minutes before and two minutes after the receiving time. The controller 420 combines the password 490 with a time within the time window to obtain multiple codes, in the same way as the collecting device encoded the time with the password. When at least one code among the multiple codes is the same as the received message, the controller 420 authenticates the received message, and transitions the dual-mode device 400 to the high-energy mode.

The memory 470 can store a dual-mode device identification (ID) 405, a project ID 415, an ID 425 of a field in the project and a value 435 associated with the field ID. The various IDs 405, 415, 425 can be occasionally updated by the collecting device 130. Alternatively, the various IDs 405, 415, 425 can be stored in a read-only memory of the dual-mode device 400. For example, the dual-mode device ID 405 can be a media access control (MAC) address, an International Mobile Equipment Identity (IMEI) number, and/or a randomly generated globally unique ID recorded into an EPROM of the dual-mode device 400. The project ID 415 can be the project ID in the central database 200 in FIG. 2. The field ID 425 can be the field ID of a record in the project in the central database 200. The value 435 can be one or more measurements recorded by the dual-mode device 400, such as air quality, temperature, etc. One or more values 435 can be stored in an ordered data structure such as a queue or a stack. In addition, the memory 470 can store a time at which each value 435 was recorded. The transmitter 450 can transmit the dual-mode device ID 405, the project ID 415 associated with the recorded data, the field ID 425, and the value associated 435 with the ID to the collecting device 130.

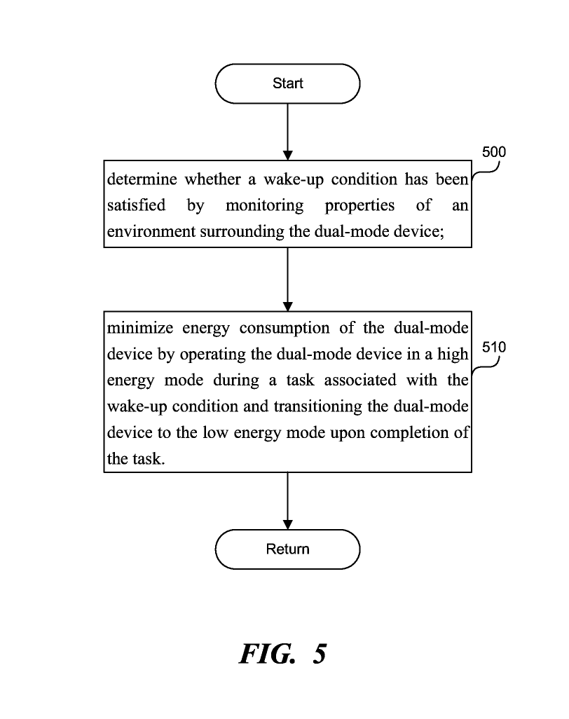

FIG. 5 is a flowchart of a method to collect data over a geographic area using inexpensive sensors. In step 500, a processor associated with a dual-mode device operating in a low-energy mode determines whether a wake-up condition has been satisfied by monitoring properties of an environment surrounding the dual-mode device.

For example, the wake-up condition can be receiving from a collecting device a wake-up message. The wake-up message can include a password to the dual-mode device. Once the processor confirms that the wake-up message contains the password to the dual-mode device, the processor can transition the dual-mode device to the high-energy mode and can transmit data stored on the dual-mode device to the collecting device. The transmitted data can include environment measurements such as humidity, air quality, availability of Wi-Fi networks, strength of cell phone signal, etc. The transmitted data can be secured by encrypting the recorded data prior to transmission to the collecting device. Once the data has been transmitted, the dual-mode device can delete the transmitted data still remaining in memory.

In another example, the wake-up condition can be passage of time. While the dual-mode device is in a low-energy mode, a timer associated with the dual-mode device measures the passage of time. The timer can measure the passage of time since the last measurement was made by the dual-mode device. After a predetermined amount of time has passed, such as two hours, the dual-mode device transitions into the high-energy mode and makes another measurement, such as one or more measurements. Upon making the measurement, the timer resets, and continues measuring the time from the latest measurement. The dual-mode device can also record the time at which the measurement was made, and store it along with the measurement in the dual device memory. Once the dual-mode device memory has been filled up, the dual-mode device can delete the recorded measurements and/or the recorded times regardless of whether the environment property stored in the memory has been transmitted to the collecting device. In another example, instead of deleting the recording measurements, the dual-mode device can start replacing the oldest recorded measurement with the newest measurement.

In addition to storing measured data, the dual-mode device memory can store a dual-mode device identification (ID), an ID associated with the recorded data and a value associated with the ID. The various IDs can be periodically updated by the collecting device, as described in this application. The dual-mode device can transmit the dual-mode device ID, the ID associated with the recorded data, and the value associated with the ID to the collecting device.

In step 510, to minimize the energy consumption of the dual-mode device, the dual-mode device can transition to the low-energy mode upon completing the task. For example, the dual-mode device can transition to the low-energy mode upon transmitting the data to the collecting device, or upon making the measurement. Once the energy source has been drained, the dual-mode device can disintegrate into the environment because the dual-mode device can be made from biodegradable conductive materials, as described in this application.

The dual-mode device can implement various security measures to guard against attacks. For example, the dual-mode device can encrypt the transmitted data using public key cryptography. The system can also guard against replay attacks. A replay attack is a form of network attack in which a valid data transmission is maliciously or fraudulently repeated or delayed. To guard against the replay attack, the dual-mode device receives from the collecting device a wake-up message and a receiving time when the message was received. The dual-mode device computes a time window around the receiving time. The time window can include five minutes before and after the receiving time. The dual-mode device starts with the initial time equaling to receiving time-5 minutes, and adds small increments, such as 0.5 second increments to the initial time, until time+5 minutes is reached. For each time so obtained, the dual-mode device combines the password stored in a memory of the dual-mode device with each time to obtain a code, and compares the code to the received message. When the code and the received message are the same, the dual-mode device authenticates the received message. This method guards against the replay attacks because it creates a time window within which the received code is valid.

### Collecting Device

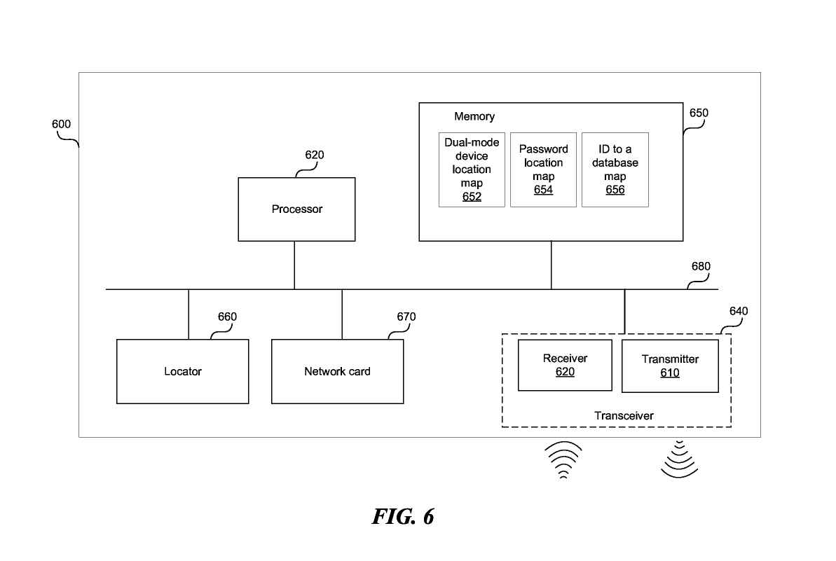

FIG. 6 shows a collecting device. The collecting device 600 can include a transmitter 610, a receiver 630, an optional transceivers 640, a processor 620, a memory 650, an optional locator 660, and a network card 670 communicating over a computer bus 680.

The collecting device 600 can be autonomously mobile or can be attached to a vehicle or a person traversing a geographic area containing multiple dual-mode devices from which the collecting device 600 gathers data. The collecting device 600 can be an autonomous drone, a self-driving vehicle, or can be attached to a car, a bike, a person, etc. The collecting device 600 can be detachable from the car, the bike, the person, etc., or the collecting device 600 can be permanently attached. As the collecting device 600 traverses the geographic area, the collecting device transitions multiple dual-mode devices into a high-energy mode, and receives and stores data transmitted by the dual-mode devices.

The geographically distributed dual-mode devices can operate in two modes, as described in this application. A first mode is a high-energy mode consuming a higher amount of energy than a second mode, which is a low-energy mode. The dual-mode devices can be completely disconnected from the Internet, or can be connected to the Internet. A dual-mode device can be a sensor to measure an environment property comprising temperature, light, noise, humidity, wind, air quality, available wireless networks, quality of cell phone reception, etc.

In one example, the collecting device 600 always operates in the high-energy mode. In another example, the collecting device 600 can operate in the high-energy mode, or in the low-energy mode depending on the location of the collecting device 600. If the collecting device 600 is located in an area where there are no dual-mode devices, the collecting device can power down to preserve energy. To determine whether the collecting device 600 is in an area where there are no dual-mode devices, the collecting device 600 can determine its location using the locator 660, and retrieve from memory 650 a map 652 indicating where the dual-mode devices are located. The collecting device 600 can determine how long it would take for the collecting device 600 to reach one or more neighboring dual-mode devices, based on the velocity of the collecting device 600 and the location of the neighboring dual-mode devices. If the length of time to reach one or more of neighboring dual-mode devices exceeds a predetermined amount of time, such as 5 minutes, the collecting device 600 can power down for 5 minutes, until it reaches a dual-mode device.

The transmitter 610 can intermittently emit into the environment a message including a wake-up signal to the dual-mode device. The message transitions the dual-mode device to the high-energy mode. The transmitter 610 can transmit the message at regular intervals such as every minute, and/or the transmitter 610 can transmit messages when the collecting device 600 is within communication distance from the dual-mode device. To determine whether the collecting device 600 is within the communication distance from the dual-mode device, the locator 660 of the collecting device 600 can determine the geographic location of the collecting device 600. The collecting device 600 can retrieve from memory 650 a map 652 containing the location of the dual-mode devices. When the distance between the collecting device 600 and the closest dual-mode device is a predetermined factor of the maximum communication distance, the collecting device 600 can emit the message containing the wake-up signal. For example, if the maximum communication distance between the collecting device 600 and the dual-mode device is 100 m, then, the collecting device can start emitting the message when the distance between the collecting device 600 and the closest dual-mode device is 150 m. In this case, the predetermined factor is 1.5.

The processor 620 of the collecting device 600 can communicate with the locator 660 over bus 680 to obtain the geographic location of the collecting device 600. Further, the processor 620 can retrieve from memory 650 a table 654 associating one or more passwords with the geographic location. The table contains information regarding which passwords are used by the dual-mode devices surrounding the geographic location. Geographically varying the passwords to the dual-mode devices increases security of the whole system by preventing access to the whole network of dual-mode devices if only one password has been compromised. The processor 620 can create the message to send to the dual-mode device based on the password associated with the geographic location. Further, the processor 620 can guard against replay attacks by encoding a current time and a password to create the message, as described in this application.

The receiver 630 of the collecting device 600 receives the recorded data from the dual-mode device. The received data can be encrypted for security reasons. The transmitter 610 and the receiver 630 can be individual components, or can be parts of a single transceiver 640.

A transmitter, such as a network card 670 upon detecting an Internet connectivity transmits the recorded data from the collecting device 600 to a database 200 in FIG. 2. The network card 670 can transmit the received data as is, and let the database determine a location within the database 200 where the received data should be stored. Alternatively, the collecting device 600 can determine where in the database 200 the received data should be stored, and send that information to the database 200.

For example, the receiver 630 of the collecting device 600 can receive the recorded data from the dual-mode device including a dual-mode device ID 405 in FIG. 4, an ID associated with the recorded data, and a value 435 in FIG. 4 associated with the ID. The ID associated with the recorded data can include the project ID 415 in FIG. 4 and field ID 425 in FIG. 4. The processor 620 can retrieve from memory 650 a mapping 656 between the received IDs 405, 415, 425 and a project and an entry in the database. The network card 670 upon detecting the Internet connectivity can transmit the recorded data, the project, and the entry, from the collecting device 600 to the database 200.

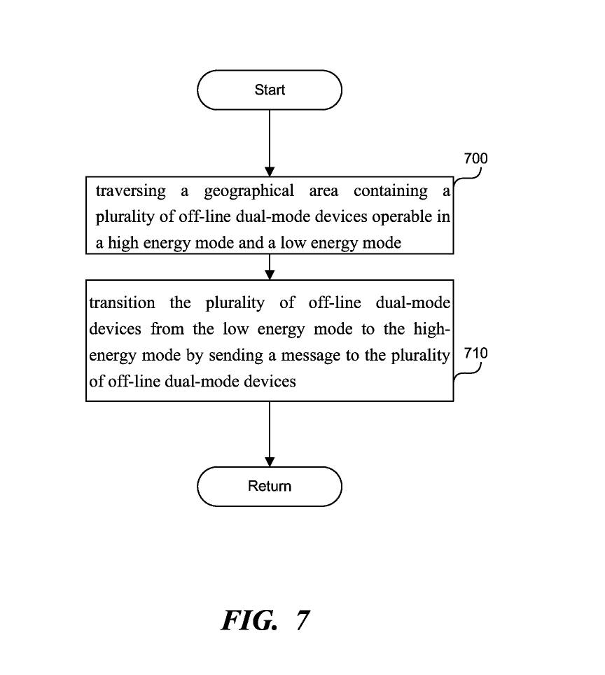

FIG. 7 is a flowchart of a method to collect data from various dual-mode devices dispersed over a geographic area using a roving collecting device. In step 700, the collecting device traverses a geographic area containing multiple off-line dual-mode devices operable in a high-energy mode and a low-energy mode. The collecting device can be detachably mounted to a moving object such as a vehicle or a pedestrian. The collecting device can itself be mobile, such as a drone, a self-driving car, etc. Each dual-mode device among the multiple off-line dual-mode devices can measure various environment properties such as temperature, light, noise, humidity, wind, air quality, available wireless networks, etc. The dual-mode devices can all measure the same property, or can measure a mixture of various properties.

In step 710, the collecting device transitions multiple off-line dual-mode devices from the low-energy mode to the high-energy mode by sending a message to the plurality of off-line dual-mode devices. Generally, the sent message can reach a dual-mode device within 100 meter radius surrounding the collecting device.

The message can be intermittently transmitted to the dual-mode devices for example at a regular interval, or when the collecting device determines that there are dual-mode devices within a 200 meter radius surrounding the collecting device, as described in this application. The message can include a wake-up signal to the dual-mode to transition the dual-mode device to the high-energy mode. The message can include a password particular to the dual-mode device, so that the dual-mode device does not transition to the high-energy mode unless the password included in the message matches the password stored on the dual-mode device. By avoiding unnecessary transitioning to the high-energy mode, the dual-mode device preserves energy. Further, the security of the dual-mode device is enhanced because the dual-mode device does not share passwords with other dual-mode devices.

After the dual-mode device transitions to the high-energy mode, the collecting device receives data stored on the dual-mode device. Once the collecting device detects an Internet connectivity, the collecting device transmits the received data to a central database. In addition, the collecting device can record a time at which the data stored on the dual-mode device was received, and send the recorded time to the database. Based on the recorded time, and the knowledge of how frequently the dual-mode device records measurements, the computer hosting the database can calculate a time at which each measurement was made. For example, if the dual-mode device makes measurements every 5 minutes, there are 100 measurements, and the recorded time at which the collecting device received the data is T, the computer hosting the database can calculate that the last measurement was made within 4 min 59 sec of time T, the second to last measurement was made within 4 min 59 sec of time T−5 min, etc.

The data received by the collecting device can include a dual-mode device ID, an ID associated with the recorded data, and a value associated with the ID. The ID associated with the recorded data can include a project ID in the database, and the field ID in the database. The field ID in the database can be unique for each measurement, or can be the same for each measurement. The collecting device, using the table lookup, can map the received IDs into a project associated with a database, and an entry associated with the database. The collecting device can transmit the received data, the project and the entry from the collecting device to a database upon detecting an Internet connectivity.

The collecting device can guard against a replay attack by encoding a current time and a password associated with the dual-mode device to create the message. Replaying the message encoding the current time and the password at a time sufficiently removed from the current time (such as two minutes after the current time) does not to grant access to the dual-mode device.

The system disclosed here can further guard against a security risk by geographically varying a password. The collecting device can determine its geographic location, and retrieve from memory a table of passwords proximate to collecting device's geographic location, for example passwords within 200 meter of the collecting device. The passwords to the multiple dual-mode devices can vary geographically. Consequently, the collecting device creates a message using the table of relevant passwords. In addition, the collecting device can encode the password along with the current time, as described in this application.

### Computer

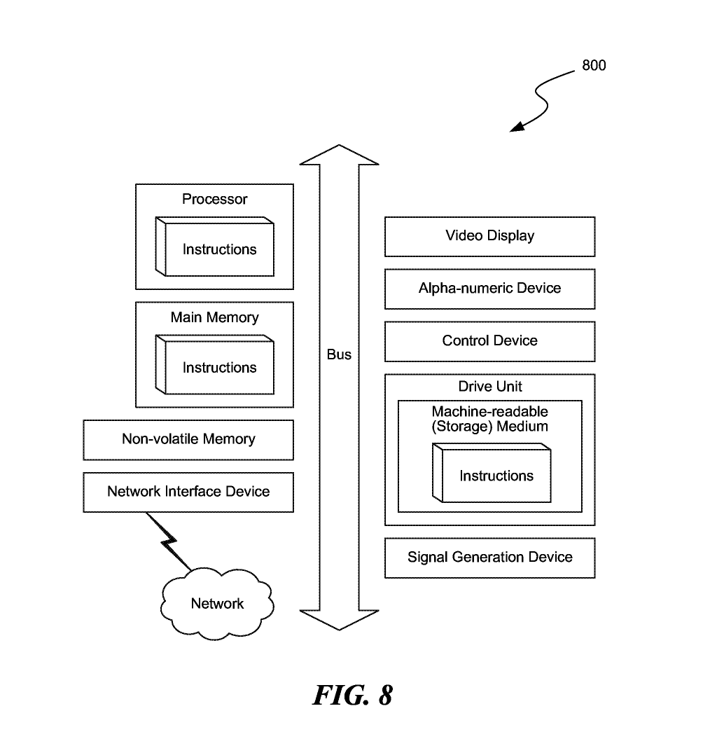

FIG. 8 is a diagrammatic representation of a machine in the example form of a computer system 800 within which a set of instructions, for causing the machine to perform any one or more of the methodologies or modules discussed herein, may be executed.

In the example of FIG. 8, the computer system 800 includes a processor, memory, non-volatile memory, and an interface device. Various common components (e.g., cache memory) are omitted for illustrative simplicity. The computer system 800 is intended to illustrate a hardware device on which any of the components described in the example of FIGS. 1-7 (and any other components described in this specification) can be implemented. The computer system 800 can be of any applicable known or convenient type. The components of the computer system 800 can be coupled together via a bus or through some other known or convenient device.

The computer system 800 can be the sensor 100, 110, 120 in FIG. 1, can be the collecting device 130 in FIG. 1, and/or can be the computer system hosting the central database 200. The memory of the computer system 800 can be the sensor memory 202, 212, 222 in FIG. 2, the collecting device memory 232 in FIG. 2, and/or memory storing the central database 200. The various devices can communicate using the network interface of the computer system 800.

This disclosure contemplates the computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 800 may include one or more computer systems 800; be unitary or distributed; span multiple locations; span multiple machines; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 800. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 800. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 8 reside in the interface.

In operation, the computer system 800 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method to collect data from a plurality of off-line devices distributed over a geographic area, the method comprising:
distributing the plurality of off-line devices without an Internet connection over the geographic area;
operating the plurality of off-line devices in at least two modes, a first mode comprising a high-energy mode to record the data from an environment and transmit the data to a collecting device, and a second mode comprising a low-energy mode to monitor the environment and to determine whether to activate the first mode;
detachably coupling the collecting device to a vehicle operable to move across the geographic area containing at least a subset of the plurality of off-line devices; and
saving power of the subset of the plurality of off-line devices when collecting the data recorded by the subset of the plurality of off-line devices by:
emitting, by the collecting device, a signal to transition the subset of the plurality of off-line devices within 100 meters radius of the collecting device from the low-energy mode into the high-energy mode;
upon transitioning the subset of the plurality of off-line devices into the high-energy mode, receiving the data transmitted by the subset of the plurality of off-line devices operating in the high-energy mode.

2. The method of claim 1, comprising measuring, by an off-line sensor in the plurality of off-line sensors, at least one of temperature, light, noise, humidity, wind, precipitation, or air quality.

3. A system comprising:
a plurality of dual-mode devices geographically distributed, a first mode associated with a dual-mode device in the plurality of dual-mode devices comprising a high-energy mode consuming a first amount of energy, and a low-energy mode associated with the dual-mode device to determine whether to activate the first mode, the low-energy mode consuming a second amount of energy, wherein the second amount of energy is less than the first amount of energy; and
a collecting device to traverse a geographic area containing at least a subset of the plurality of dual-mode devices, to save power of the subset of the plurality of dual-mode devices when collecting data recorded by the subset of the plurality of dual-mode devices by:
emitting, by the collecting device, a signal to transition the subset of the plurality of dual-mode devices into the high-energy mode, and
upon transitioning the subset of the plurality of dual-mode devices into the high-energy mode, receiving the data transmitted by the subset of the plurality of dual-mode devices.

4. The system of claim 3, the dual-mode device not connected to the Internet.

5. The system of claim 3, the dual-mode device comprising a sensor to measure an environment property comprising temperature, light, noise, humidity, wind, air quality, or available wireless networks.

6. The system of claim 3, the collecting device detachably coupled to a moving object comprising a vehicle or a pedestrian.

7. The system of claim 3, the collecting device comprising an autonomous vehicle.

8. The system of claim 3, the collecting device comprising:
a transmitter to intermittently emit a message comprising a wake-up signal to the dual-mode device and to transition the dual-mode device to the high-energy mode.

9. The system of claim 3, the collecting device comprising:
a processor to guard against replay attacks by encoding a time and a password to create a message.

10. The system of claim 3, the collecting device comprising:
a processor to determine a geographic location of the collecting device, to retrieve a password from a table associating the password with the geographic location, and to create a message based on the password.

11. The system of claim 3, the collecting device comprising:
a receiver to receive the data recorded by the dual-mode device; and
a transmitter upon detecting an Internet connectivity to transmit the data recorded by the dual-mode device from the collecting device to a database.

12. The system of claim 3, the collecting device comprising:
a receiver to receive the data recorded by the dual-mode device, the data recorded by the dual-mode device comprising a dual-mode device ID, an ID associated with the data recorded by the dual-mode device, and a value associated with the ID;
a processor to map the data recorded by the dual-mode device into a project associated with a database, and an entry associated with the database; and
a transmitter upon detecting an Internet connectivity to transmit the data recorded by the dual-mode device, the project, and the entry, from the collecting device to the database.

13. A method comprising:
traversing a geographic area containing a plurality of off-line dual-mode devices operable in a high-energy mode and a low-energy mode; and
saving power of the plurality of off-line dual-mode devices when collecting data recorded by the plurality of off-line dual-mode devices by:
emitting, by a collecting device, a signal to transition the plurality of off-line dual-mode devices from the low-energy mode to the high-energy mode by sending a message to the plurality of off-line dual-mode devices.

14. The method of claim 13, comprising sending the message capable of reaching a dual-mode device in the plurality of off-line dual-mode devices within 100 meters radius surrounding the collecting device.

15. The method of claim 13, comprising:
measuring, by a dual-mode device in the plurality of off-line dual-mode devices an environment property comprising temperature, light, noise, humidity, wind, air quality, or available wireless networks.

16. The method of claim 13, comprising detachably mounting the collecting device to a moving object comprising a vehicle or a pedestrian.

17. The method of claim 13, comprising:
intermittently transmitting the message comprising a wake-up signal to a dual-mode device in the plurality of off-line dual-mode devices; and
transitioning the dual-mode device to the high-energy mode.

18. The method of claim 17, comprising preserving energy associated with the dual-mode device by including a password within the message, thereby avoiding unnecessary transitioning a second dual-mode device not associated with the password to the high-energy mode.

19. The method of claim 17, comprising:
guarding against a replay attack by encoding a current time and a password associated with the dual-mode device to create the message.

20. The method of claim 17, comprising guarding against a security risk by geographically varying a password, said guarding comprising:
determining a geographic location of the collecting device;
retrieving the password from a table associating the password with the geographic location; and
creating the message based on the password.

21.-24. (canceled)
